(19) United States
(12) Patent Application Publication
(10) Pub. No.: US 2025/0207772 A1
(43) Pub. Date: Jun. 26, 2025

(54) MODULAR PRESSURIZED COAL COMBUSTION PLANT (MCCP) FOR FLEXIBLE GENERATION

(71) Applicants: Richard Axelbaum, St. Louis, MO (US); Zhiwei Yang, St. Louis, MO (US); Piyush Verma, St. Louis, MO (US)

(72) Inventors: Richard Axelbaum, St. Louis, MO (US); Zhiwei Yang, St. Louis, MO (US); Piyush Verma, St. Louis, MO (US)

(73) Assignee: Washington University, St. Louis, MO (US)

(21) Appl. No.: 19/002,716

(22) Filed: Dec. 27, 2024

Related U.S. Application Data
(63) Continuation of application No. 16/938,725, filed on Jul. 24, 2020, now Pat. No. 12,222,101.
(60) Provisional application No. 62/880,558, filed on Jul. 30, 2019.
(60) Provisional application No. 62/878,063, filed on Jul. 24, 2019.

(51) Int. Cl. F23C 9/00; F22B 1/22; F22B 9/00; F23C 6/00; F23C 99/00; F23J 15/02; F23J 15/06; F23K 3/00; F23L 7/00

(52) U.S. Cl. CPC F23C 9/003; F22B 1/22; F23C 6/00; F23C 99/00; F23J 15/02; F23J 15/025; F23J 15/06; F23K 3/00; F23L 7/007; F22B 9/00; F23C 2202/00

(57) ABSTRACT

A modular pressurized combustion system for flexible energy generation is provided. The system comprises a plurality of pressurized combustion boilers, at least one compressor configured to provide pressurized oxidizer gas to each of the plurality of pressurized combustion boilers in parallel, and at least one feeder configured to provide fuel to each of the plurality of pressurized combustion boilers in parallel. The system further comprises a flue gas input unit configured to provide recycled flue gas to each of the plurality of pressurized combustion boilers in series, at least one pressurized heat recovery unit configured to receive a flue gas output stream from each of the plurality of pressurized combustion boilers, and at least one particle filter configured to filter a flue gas output stream from the pressurized heat recovery unit. The system also comprises an integrated pollutant removal unit.

### CROSS-REFERENCE TO RELATED APPLICATIONS

This application is a continuation of U.S. Non-Provisional application Ser. No. 16,938,725 filed Jul. 24, 2020. This application claims benefit of priority to U.S. Provisional Application Ser. No. 62/878,063 filed on Jul. 24, 2019, which is incorporated herein by reference in its entirety. This application further claims benefit of priority to U.S. Provisional Application Ser. No. 62/880,558 filed on Jul. 30, 2019, which is incorporated herein by reference in its entirety.

### STATEMENT REGARDING FEDERALLY FUNDED RESEARCH AND DEVELOPMENT

This invention was made with government support under RFP-89243319RFE000015 awarded by the U.S. Department of Energy. The government has certain rights in the invention.

### BACKGROUND OF THE DISCLOSURE

The field of the disclosure relates generally to fuel combustion systems. More specifically, the field of the disclosure relates to modular pressurized coal combustion (MPCC) for flexible energy generation.

The rapid addition of intermittent renewable energy (IRE) has created a growing need for responsive, dispatchable generation to provide grid stability. However, existing coal power plants, which have been pressed into operating more flexibly than originally designed in response to the growth of IRE, are being retired at alarming rates due in some cases to not being cost competitive (e.g., in the U.S., where cheaper natural gas power often prevails), environmental concerns, or not being able to be flexible enough, and these retirements are putting the reliability of the grid at risk. Moreover, coal adds to the diversity of the overall generational mix, an important hedge against future changes, e.g., price volatility of natural gas. In view of this, a new breed of coal power plants is needed that is clean, efficient and flexible to meet the changing market demands. Also, due to the impact of CO₂ on climate change, the potential ability to be readily retrofitted a carbon capture plant is also an important feature for future coal power plants.

Due to its large reserves, ease of transportation and storage, low price, coal is expected to persist as one of main energy sources for generating power into the distant future. As more of the grid electricity is generated from intermittent renewable sources (IREs), the existing coal-fired power plants, optimized for baseload, are being increasingly relied on as load-following resources, which adds challenges to plant operations and hurts the economics of the plant. There is a need for a new concept for coal plants, where the plant will have a high efficiency (>40% HHV), increased operational flexibility with high ramp rates and minimal reduction of efficiency at part load, modular construction with low capital cost, and low emissions with the potential to be retrofitted for carbon capture without significant plant modifications. Additional features include integration with energy storage, minimized water consumption, reduced design, construction and commissioning schedules, enhanced maintenance features, integration capability with coal upgrading, and natural gas co-firing capability. The following disclosure is designed to address this need. The systems and methods described herein are intrinsically modular in design, flexible, carbon-capture ready, and have high efficiency and low water use.

### BRIEF DESCRIPTION OF THE DISCLOSURE

In one aspect, a modular pressurized combustion system for flexible energy generation is provided. The system comprises a plurality of pressurized combustion boilers, at least one compressor configured to provide pressurized oxidizer gas to each of the plurality of pressurized combustion boilers in parallel, and at least one feeder configured to provide fuel to each of the plurality of pressurized combustion boilers in parallel. The system further comprises a flue gas input unit configured to provide recycled flue gas to each of the plurality of pressurized combustion boilers in series, at least one pressurized heat recovery unit configured to receive a flue gas output stream from each of the plurality of pressurized combustion boilers, and at least one particle filter configured to filter a flue gas output stream from the pressurized heat recovery unit. The system also comprises an integrated pollutant removal unit.

In another aspect, a process for flexible energy generation using a modular pressurized combustion system is provided. The process comprises providing, with at least one compressor, pressurized oxidizer gas to each of a plurality of pressurized combustion boilers in parallel, providing, with at least one feeder, fuel to each of the plurality of pressurized combustion boilers in parallel, and providing, with at least one flue gas input unit, recycled flue gas to each of the plurality of pressurized combustion boilers in series. The process further comprises recovering, with at least one heat recovery unit, heat from a flue gas output stream received from each of the plurality of pressurized combustion boilers, filtering, with at least one particle filter, a flue gas output stream from the at least one pressurized heat recovery unit, and cooling, with at least one integrated pollutant removal unit, a particle-free flue gas output stream received from the at least one particle filter.

In yet another aspect, a system for controlling wall heat flux in a pressurized coal combustion environment is provided. The system comprises at least one burner and at least one low-mixing, axial-flow boiler.

### BRIEF DESCRIPTION OF THE DRAWINGS

The following drawings illustrate various aspects of the disclosure.

FIG. 1 is a simplified process flow diagram illustrating a modular pressurized coal combustion plant with four modular boilers in accordance with one aspect of the present disclosure.

FIG. 2 is a simplified process flow diagram illustrating a staged, pressurized oxy-combustion plant retrofitted from the modular pressurized coal combustion plant shown in FIG. 1 in accordance with one aspect of the present disclosure.

FIG. 3A is a schematic illustration of a boiler that includes a burner with a fuel port positioned between nested inner and outer oxidizer ports in accordance with one aspect of the present disclosure.

FIG. 3B is a schematic illustration of a boiler that includes a burner with an oxidizer port nested within an outer fuel port in accordance with another aspect of the present disclosure.

FIG. 4A is a graph summarizing wall heat flux associated with the combustion of fuel with a particle size range ranging from about 5 μm to about 200 μm, as is used in conventional pressurized combustion (PC) boilers, in a low-mixing, axial-flow boiler in accordance with one aspect of the present disclosure. Negative heat flux is associated with heat transferred from the inside (fire side) of the boiler wall to the outside (water side) of the boiler wall.

FIG. 4B is a graph summarizing wall heat flux associated with the combustion of fuel with a bimodal particle size range ranging from about 10 μm to about 200 μm and from about 1600 μm to about 2000 μm in the boiler of FIG. 4A.

FIG. 5A is a heat map illustrating a temperature contour observed by an operational simulation of the boiler of FIG. 3A.

FIG. 5B is a heat map illustrating a temperature contour observed by an operational simulation of the boiler of FIG. 3B.

FIG. 6A is a graph summarizing the axial distribution of wall heat flux for the boiler of FIG. 3A.

FIG. 6B is a graph summarizing the axial distribution of wall heat flux for the boiler of FIG. 3B.

FIG. 7A is a simplified flow chart illustrating staged combustion system with flue gas recirculation.

FIG. 7B is a graph illustrating a representative profile of flue gas temperature during operation of the staged combustion system of FIG. 7A.

FIG. 8A is a heat map illustrating a temperature profile of a flame from a swirl stabilized burner within a boiler.

FIG. 8B is a heat map illustrating a temperature profile of a flame from an axial jet burner within a boiler.

FIG. 9 is a graph comparing the wall heat flux of boilers outfitted with the swirl stabilized burner of FIG. 8A (A) and the axial jet burner of FIG. 8B.

FIG. 10 is a graph comparing measured and simulated particle temperatures during early stage operation of a boiler in accordance with one aspect of the disclosure.

FIG. 11A is a graph summarizing thermal energy input and flue gas oxygen concentration during operation of a boiler in accordance with one aspect of the disclosure at an energy input of about 100 kW.

FIG. 11B is a graph summarizing thermal energy input and flue gas oxygen concentration during operation of a boiler in accordance with one aspect of the disclosure at an energy input of about 50 kW.

FIG. 11C is a graph summarizing thermal energy input and flue gas oxygen concentration during operation of a boiler in accordance with one aspect of the disclosure at an energy input of about 120 kW.

FIG. 12 is a graph summarizing char gasification and oxidation rates during operation of a boiler in accordance with one aspect of the disclosure at boiler pressures of about 1 bar and about 15 bar.

FIG. 13 is a graph summarizing a furnace wall temperature profile during operation of a boiler in accordance with one aspect of the disclosure at an energy input of about 120 kW.

Those of skill in the art will understand that the drawings, described below, are for illustrative purposes only. The drawings are not intended to limit the scope of the present teachings in any way.

### DETAILED DESCRIPTION OF THE DISCLOSURE

### Modular Pressurized Coal Combustion (MPCC) for Flexible Generation

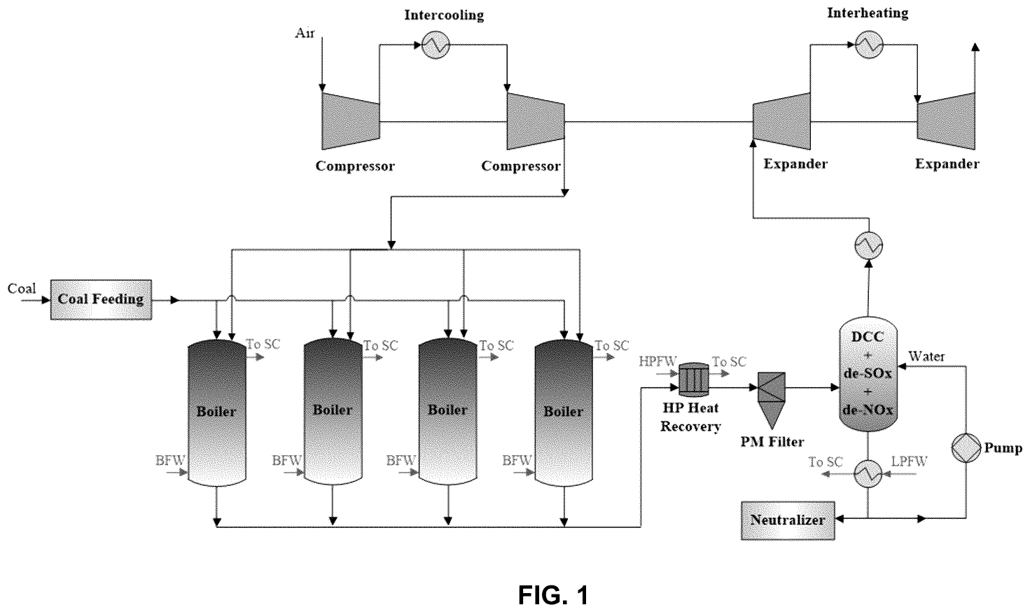

The proposed concept incorporates pressurized coal combustion with a modular boiler design. A high-level process flow diagram for the proposed concept is given in FIG. 1. FIG. 1 is an exemplary embodiment of a simplified process flow diagram for a modular pressurized coal combustion plant with four modular boilers in accordance with the present disclosure. The process consists of multiple pressurized combustion boilers arranged in parallel. In FIG. 1, four pressurized boilers are included, although the optimum number will depend on the application. Air is compressed with a single-or multi-stage compressor before entering the boilers with crushed or pulverized coal. Coal is delivered via a feeder with a small amount of recycled flue gas. Coal and pressurized air are delivered to each of the boilers in roughly equal amounts. The boilers nominally have the same design and operating conditions. While the pressure in the boilers can range from 10 to 40 bar (absolute), in the example shown in FIG. 1, 16 bar (absolute) is used. In the boiler, the heat of combustion is transferred to a power cycle to generate electricity. The power cycle can be a supercritical (SC) steam-Rankine cycle (as shown in FIG. 1), a high-efficiency advanced ultra-supercritical (A-USC) steam-Rankine cycle, an indirect-fired supercritical CO₂ cycle, or another power cycle.

Downstream of the pressurized boilers, the flue gas streams are combined and fed into a pressurized heat recovery unit. In this unit, heat is extracted and integrated into the power cycle and the flue gas is cooled to slightly above the acid dew point temperature. After the pressurized heat recovery unit, fly ash particles in the flue gas are removed by a particle filter.

After particulate removal, the flue gas is further cooled in an integrated pollutant removal (IPR) unit. The IPR unit is a single, direct-contact cooling (DCC) column, in which the flue gas flows against a stream of cooler water, thereby reducing the flue gas temperature and resulting in condensation of the flue gas moisture. The water leaving the bottom of the column is at sufficiently high temperature that can be used for boiler feed water heating and the plant thermal efficiency is improved. Due to the high-pressure operation, sulfur-and nitrogen-containing species are dissolved in the cooling water and removed. This process of pollutant removal, which is effective only under pressure, combined with latent heat recovery, are key benefits of the MPCC process.

After the IPR unit, the clean, particle-free flue gas is heated back to a higher temperature using part of the IPR heat. The heated flue gas then goes through a single- or multi-stage expansion turbine to produce power. If multi-stage compressors and multi-stage expansion turbines are employed, the compression heat will be recovered by intercooling and then this heat will be used to heat the flue gas between turbine stages to increase the power output. In this way, most of the work used by the compressors is compensated by the power generated from the expansion turbines. The remaining part of the compressor work becomes the auxiliary load of the plant. The proposed concept has several important advantages over the conventional atmospheric-pressure PC plant. Advantages include:

1) Higher efficiency through recovering flue gas latent heat—As mentioned above, with high pressure, the latent heat from the flue gas can be utilized to increase plant efficiency. The temperature at which moisture condensation occurs in the flue gas is strongly dependent on operating pressure. The significant increase in condensation temperature makes it feasible to utilize the latent heat at pressure. Also, the extra power produced by integrating this latent heat into the power cycle is considerably higher than the net auxiliary load for pressurization, so that a power plant incorporating the proposed concept has a higher plant efficiency. Calculations show that, for the plant configuration shown in FIG. 1, the proposed plant has ˜1.3 percentage points increase in plant efficiency compared with a conventional PC plant utilizing a similar steam cycle.

2) Economical pollutant removal—In a pressurized system, SOₓ and NOₓ and some mercury can be removed simultaneously in a cooling column. The advantages of this approach over others include: 1) the capture of SOₓ and NOₓ occurs simultaneously, which is more economical than separate removal processes such as selective catalytic reduction (SCR) for NOₓ removal and sorbent injection for SO₂; 2) large pieces of equipment, like SOₓ scrubbers and SCRs, are eliminated, resulting in significant capital cost savings; and 3) acid gas condensation is controlled to occur only in a single vessel, eliminating the chances of corrosion in other parts of the system.

3) Reduced gas volume—Compared with atmospheric pressure PC combustion, the overall volume of gas is significantly reduced in a pressurized system. This provides further opportunity to reduce the size of the boiler, pumps, and other equipment. Heat loss to the ambient is also reduced. Importantly, the volume of gas undergoing treatment for removal of ash and other contaminants is reduced, while the concentrations of these contaminants is increased, making their removal easier and more cost effective.

4) Improved coal combustion rate—In coal-fired combustion systems, the amount of air supplied is kept to a minimum to avoid efficiency loss and to minimize the auxiliary load associated with air delivery. In addition, it is important to keep the amount of unburned carbon in the fly ash below levels required for fly ash reuse applications. In a conventional PC plant, the oxygen concentration in the flue gas is normally kept above a minimum value, typically 2.5 vol %. However, studies have shown that coal conversion rates under pressurized conditions are higher, because both char oxidation and gasification rates increase. Also, the gas volume in a boiler decreases proportionally with pressure, reducing velocity and increasing residence time. This further increases the coal conversion at the exit of the boiler. Therefore, the oxygen concentration in the flue gas can be smaller in a pressurized boiler. This effectively reduces the amount of air needed. In addition, with enhanced coal combustion rate, the coal particle size can be larger, which means the auxiliary load for coal pulverizing can be reduced.

5) Increased combustion performance of lower-quality fuels—Some low-rank fuels, such as lignite, have limited use due to their high moisture and low energy content. Since much of the latent heat in the flue gas can be captured in pressurized combustion, the effective heating value of “low-Btu” fuels can be significantly increased.

6) Modular boiler construction—An important advantage of the proposed process is the ability to modularize the construction of the pressurized boiler. Because of the long, thin nature of pressure vessels, they can be built in a factory using skilled labor and high-quality control procedures, and then shipped to the power plant location. This approach is particularly important to the U.S., as some recent advanced coal technology projects have encountered construction delays and cost overruns due to the inability to ensure large numbers of experienced craftsmen to work in remote, rural locations where power plants are often sited. The use of modular construction will facilitate lower construction costs, on-time and within-budget plant construction, and better quality control.

7) Improved plant flexibility—Compared with a conventional PC power plant, the operating flexibility of the proposed plant is increased due to the parallel boiler design. The minimal load for a typical conventional PC plant is ˜25%. There is an efficiency drop at part-load operation, due in part to the mismatch of heat transfer in the radiant and convective sections of the boiler. For the proposed conceptual plant, 25% load can be easily achieved by just shutting down three boiler modules. The efficiency drop caused by heat transfer mismatch can be minimized as the operating condition of the remaining module is full load. Thus, a much deeper turn-down can be achieved with the modular design. Also, the ramp rate and cool/warm start-up time of the proposed conceptual plant should also be higher than a conventional PC plant since the size of each boiler module is relatively small.

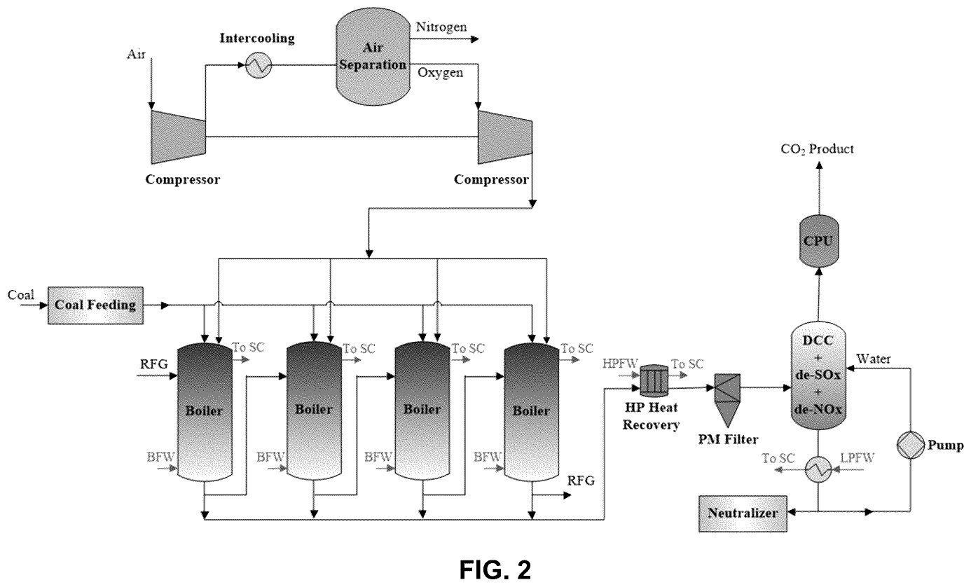

8) Carbon-capture ready—The proposed plant can be readily retrofitted to the staged, pressurized, oxy-combustion (SPOC) process, one of the most promising carbon capture technologies for coal power plants. FIG. 2 shows an oxy-coal process retrofitted from the process shown in FIG. 1. The following modifications are made: (a) An air separation unit (ASU) is added between compressor stages to produce oxygen. For a typical cryogenic ASU, more than 98% of the energy load is for air compression. As air is already compressed in this process, the energy penalty of adding an ASU is minimal. (b) The expansion turbines are replaced by a CO₂ purification unit (CPU) to produce CO₂ that is ready for transportation, utilization and/or storage. Since the expansion turbines are removed, the compression heat extracted from the multi-stage compressors can now be integrated into the power cycle to increase power output. (c) The boilers are connected into a series-parallel configuration, unique to the SPOC process, in which a small amount of the flue gas coming out of the last-stage boiler is recycled back into the first stage. This recycled flue gas is used to dilute the oxygen entering the first-stage boiler. Then part of the flue gas coming out of the first-stage boiler is fed into the second stage to dilute the oxygen flow in this stage. The same process occurs for all downstream stages (i.e., oxygen is always mixed with part of the flue gas from the previous stage before it enters the present stage). This unique mode of operation minimizes flue gas recycle and maximizes efficiency. By adjusting the flow rates of the flue gas entering each stage, all stages can have similar operating conditions. Therefore, the plant still maintains high flexibility, since low load can still be achieved by shutting down one or more boilers.

### Dry-Feed Pressurized Combustion Boiler Design

Thermal radiation from a particle-laden flue gas stream can be greatly enhanced by pressure. Utilizing conventional coal combustion boiler designs under pressure can lead to excess wall heat fluxes and damages to the water-cooling walls. Therefore, a new boiler design is required for pressurized coal combustion.

A novel method is disclosed herein to control wall heat flux to within an acceptable level under pressurized coal combustion environment. This method incorporates two approaches: creating a low-mixing, axial-flow system and combusting coal particles with a tailored size distribution, to distribute heat release.

Conventional pulverized coal (PC) combustion boilers typically utilize tangential flow to enhance mixing and increase particle residence time, and also utilize very fine coal particles (typical mean and maximum sizes are around 75 μm and 200 μm, respectively) to increase burning rate. All these features are to ensure complete char combustion. In a pressurized combustion boiler, complete char combustion is less of a concern due to the high oxygen partial pressure and longer residence time. Therefore, a low-mixing, axial-flow boiler can be utilized to distribute heat release and thus lower the peak wall heat flux. Unlike a tangentially fired combustion boiler, which releases all the combustion energy in a short distance, a low-mixing, axial-flow boiler can create a longer flame and release combustion energy in a longer distance. Also, a much wider particle size range can be utilized to help distribute heat release. Due to different heating rates, different sized particles ignite at various locations, and burn at different speeds. A wider particle size range can effectively distribute the release of the combustion energy. With a tailored particle size distribution, we can even manipulate the heat flux profile along the height of the boiler, which gives us an opportunity to optimize steam integration.

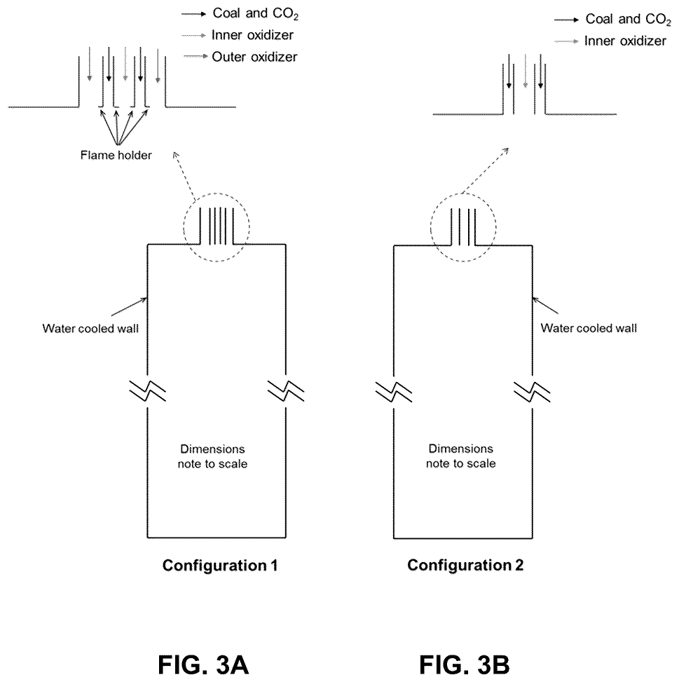

With above design concepts, different burn configurations can be utilized for enhanced heat flux control in a coal-fired SPOC system. The burner designs can be used independently or coupled with particle size distribution control to enhance the ability to control heat flux to the boiler tubes. This allows additional flexibility to design the boiler tubes for more efficient steam production across a wider variety of operating conditions. FIG. 3 shows two examples of burner and boiler designs. The two designs have the same boiler geometry: a cylinder combustor with water-cooled walls, but the burners have different configurations. In the first configuration, the burner is a co-axial flow system, which consists of three streams. The inner stream is the inner oxidizer, the outer stream is the outer oxidizer, and the coal stream is between the two oxidizer streams together with a small amount of carrier CO₂. On both the inner and outer side of the exit of the coal stream tube, there is a flame stabilizing anchor. In the second configuration, there are only two streams, all the oxidizer is fed into the center tube, coal and carrier CO₂ is surrounding the oxidizer. Both burner configurations can create a relatively long flame, compared with the tangentially-fired boilers typically used in conventional coal combustion boilers. The unique burner designs and use of particle distributions effectively control the burn, provide additional heat distribution control, and provide an improved alternative option to conventional SPOC process burners/boilers.

With above design concepts, different burn configurations can be utilized. FIG. 3 shows two examples of burner and boiler designs. The two designs have the same boiler geometry: a cylinder combustor with water-cooled walls, but the burners have different configurations. In the first configuration, the burner is a co-axial flow system, which consists of three streams. The inner stream is the inner oxidizer, the outer stream is the outer oxidizer, and the coal stream is between the two oxidizer streams together with a small amount of carrier CO₂. On both the inner and outer side of the exit of the coal stream tube, there is a flame stabilizing anchor. In the second configuration, there are only two streams, all the oxidizer is fed into the center tube, coal and carrier CO₂ is surrounding the oxidizer. Both burner configurations can create a relatively long flame, compared with the tangentially-fired boilers typically used in conventional coal combustion boilers.

### EXAMPLES

The following Examples describe or illustrate various embodiments of the present disclosure. Other embodiments within the scope of the appended claims will be apparent to a skilled artisan considering the specification or practice of the disclosure as described herein. It is intended that the specification, together with the Examples, be considered exemplary only, with the scope and spirit of the disclosure being indicated by the claims, which follow the Examples.

### EXAMPLE 1: Projected Cost and Performance Estimates

To evaluate the cost and performance of a modular pressurized coal combustion power plant as described above, the following experiments were conducted. A preliminary process analysis was carried out using plant configurations and steam cycles parameters as summarized in Table 1 below. NETL Base Case was selected as representative of a conventional supercritical (SC) steam-Rankine cycle pressurized combustion (PC) plant. MPCC Case 1 employed a SC steam cycle with single reheat. MPCC Case 2 employed an advanced ultra-supercritical (A-USC) steam-Rankine cycle with double reheat. The estimated performance for each of these cases is summarized in Table 1.

TABLE 1
Performance comparison for conceptual
plant with different steam cycles.

| | | Net |
|---|---|---|
| | | efficiency, |
| Case | Steam pressure/temperature/reheat temp | HHV (%) |
| Conventional SC | 3500 psig/1100° F./1100° F./— | 40.7 |
| Power plant | | |
| MPCC Case 1 | 3500 psig/1100° F./1100° F./— | 42.0 |
| MPCC Case 2 | 4200 psig/1300° F./1200° F./1200° F. | 44.3 |

The levelized cost of electricity (LCOE) for the MPCC Case 1 was expected to be less than that for a conventional PC plant with the same power cycle. Even though the air compressors and flue gas expansion turbines added capital cost to the plant, the integrated pollutant removal (IPR) unit of MPCC Case 1, which combined latent heat recovery with SOₓ and NOₓ removal in a compact direct-contact cooling (DCC) column, replaced the traditional and expensive emission control equipment of the Conventional SC Power Plant. In addition, in pressurized combustion power systems such as MPCC Cases 1 and 2, the boilers, pumps, and other equipment were smaller, and though the pressure vessels for the boilers added additional cost, the modular boiler design allowed mass production of boilers in a factory using skilled labor with high-quality control procedures, which reduced estimated construction costs. Further, for a given-sized plant (i.e., electricity output), the higher efficiency of the MPCC Cases 1 and 2 lead to lower capital and operational costs as compared to the Conventional SC Power Plant. Considering previous economic analyses conducted for SPOC process (not included), the LCOE for MPCC plants is expected to be ˜20% less than a conventional PC plant of comparable size and power cycle configuration.

### EXAMPLE 2: Performance of Axial Flow Boiler

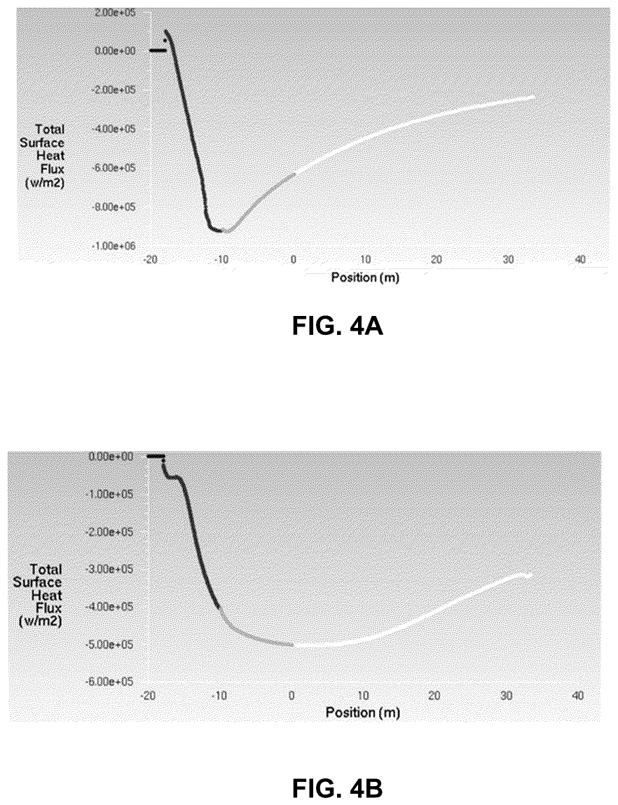

FIGS. 4A and 4B are exemplary embodiments of wall heat flux in a low-mixing, axial-flow boiler in accordance with the present disclosure and show the comparison of wall heat fluxes between a combustion case with a typical particle size range (10˜200 μm) in conventional PC boilers and a case with a bimodal particle size range (10˜200 μm and 1600˜2000 μm) under oxy-combustion conditions. FIG. 4A illustrates a typical particle size range (5˜200 μm) used in conventional PC boilers. FIG. 4B illustrates a bimodal particle size range (10˜200 μm and 1600˜2000 μm). Note that negative heat flux means heat is transferred from the inside (fire side) of the wall to the outside (water side) of the wall. Also note that the proposed boiler design works for both air combustion mode and oxy-combustion mode. Oxy-combustion typically has higher radiative heat flux than air combustion due to the higher CO₂ concentration. Therefore, oxy-combustion is used in the examples to illustrate the effectiveness of the method disclosed herein in controlling wall heat flux.

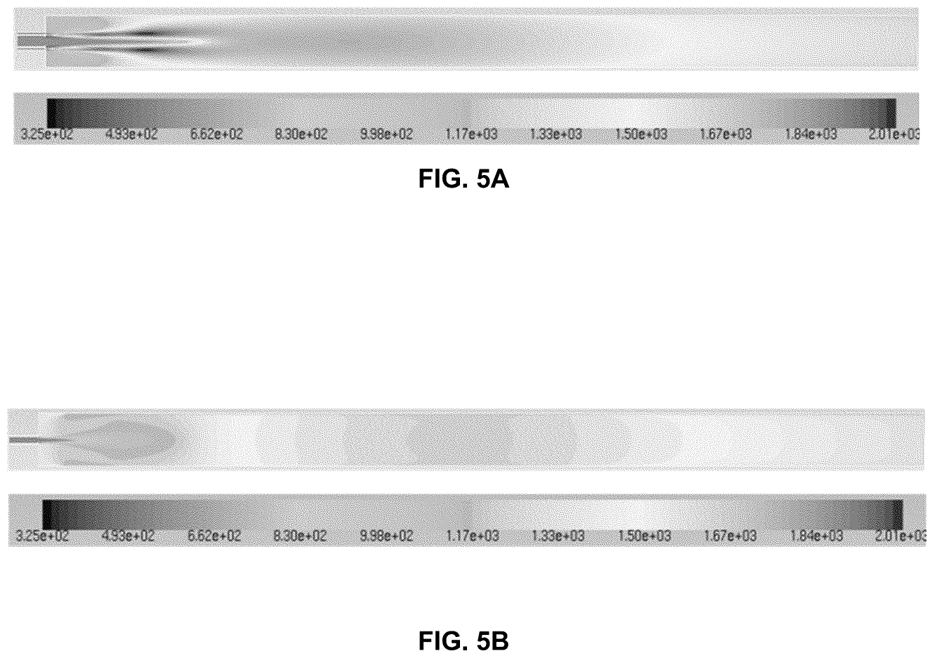

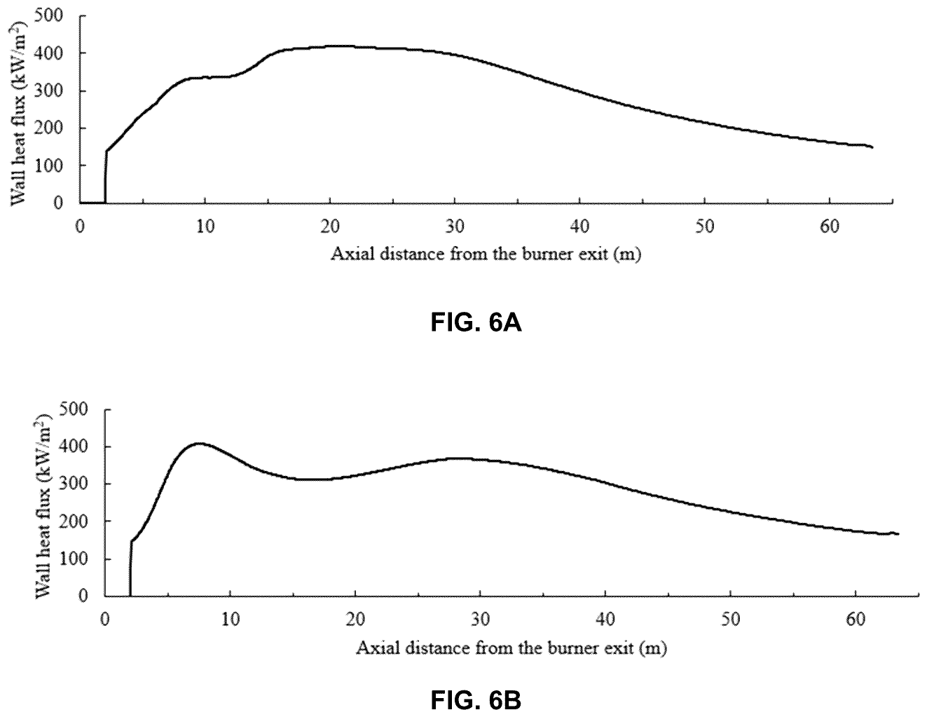

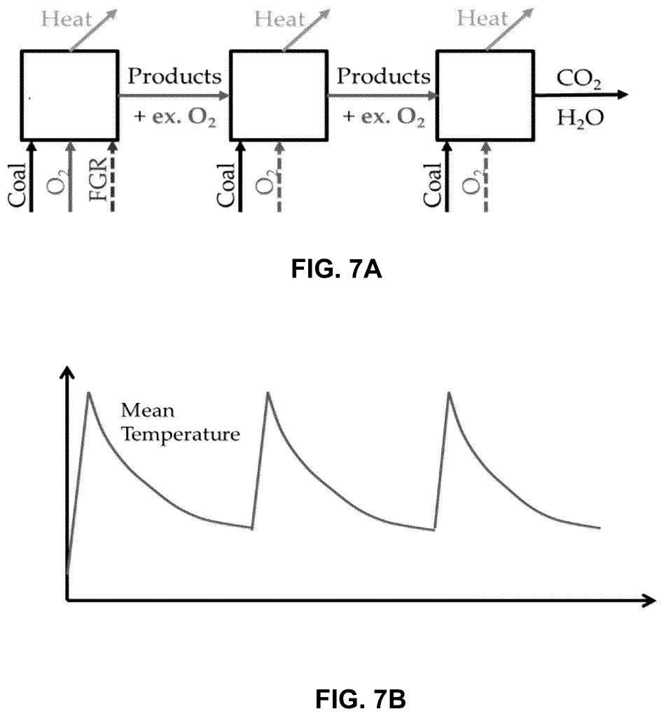

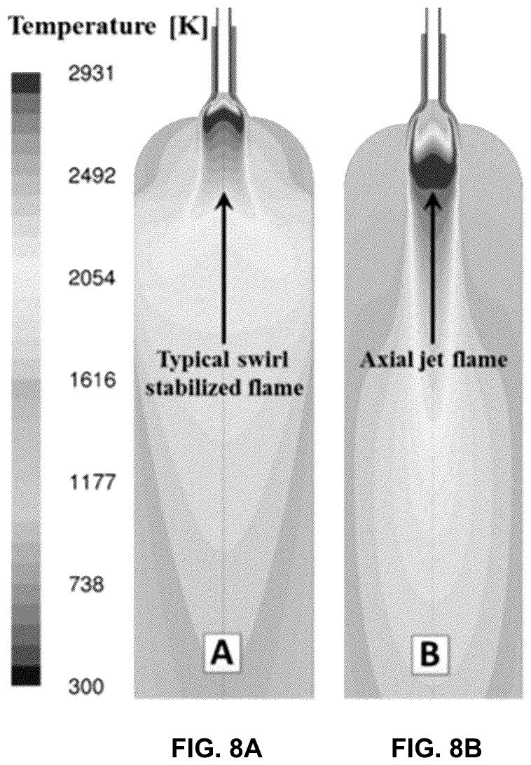

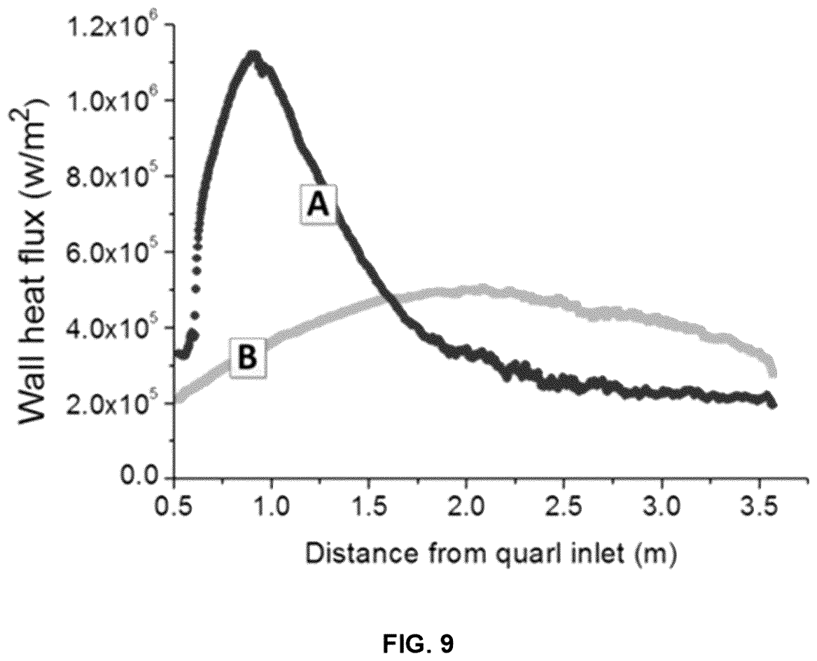

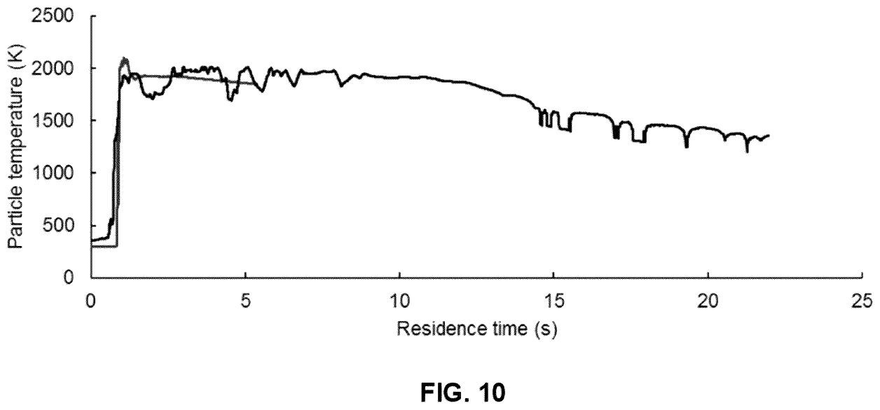

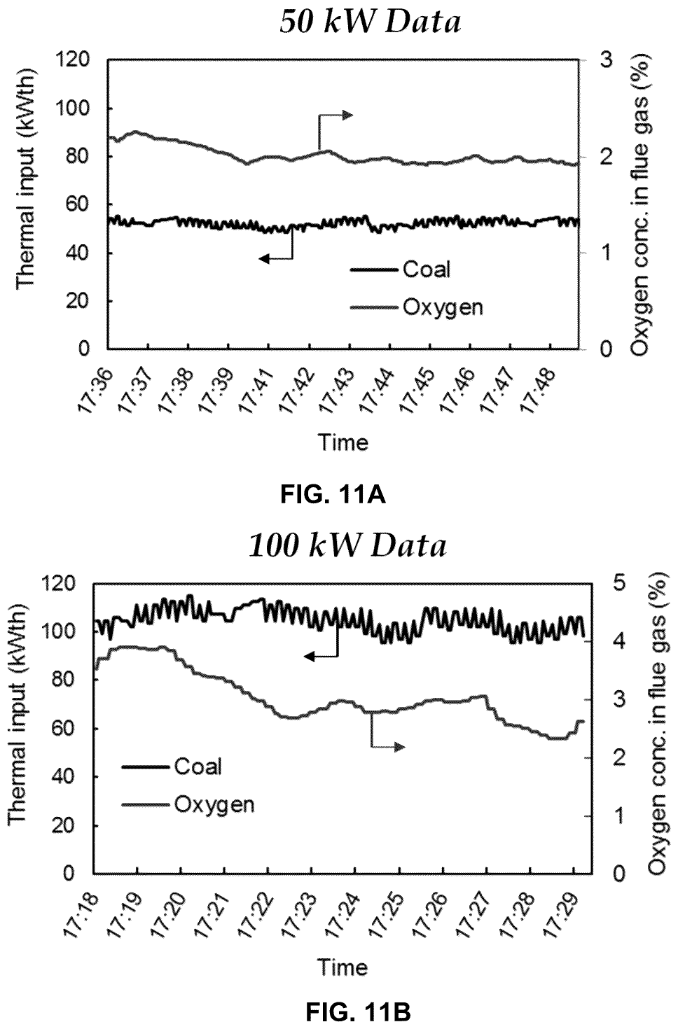

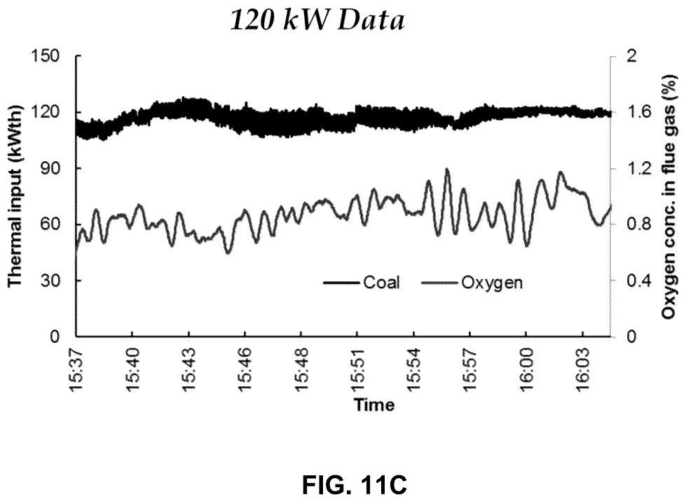

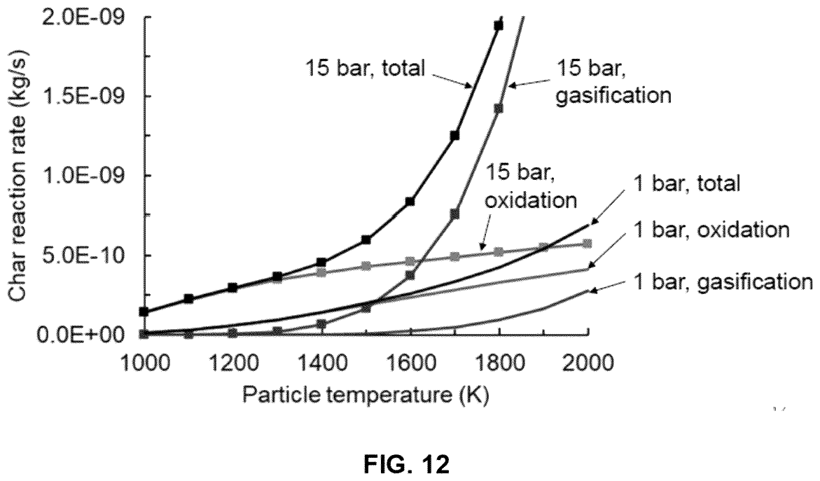

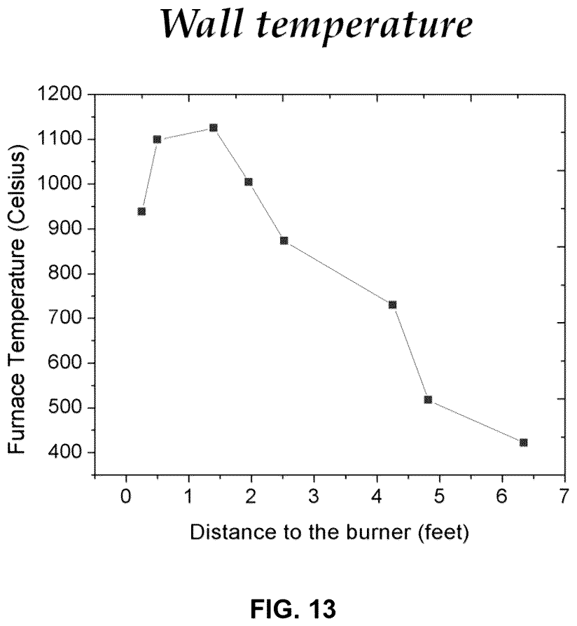

FIGS. 5A-5B and 6A-6B show the temperature contours and wall heat fluxes of the two burner configurations, respectively. FIGS. 5A and 5B illustrate the temperature contour for design configurations 1 and 2, respectively, as shown in FIG. 3. FIGS. 6A and 6B illustrate the wall heat flux for design configurations 1 and 2, respectively, as shown in FIG. 3. The operating pressure is 15 bar. A bimodal particle size range (5˜200 μm and 1600˜2000 μm) is used in the simulation. Note that this bimodal particle size range is an example. The particle size range and distribution that can be used in these boiler designs is not limited to this example and will depend on the heat flux profile needed. Simulation shows that with a conventional tangentially-fired boiler design, the peak heat flux is higher than 800 kW/m² when the operating pressure is 15 bar. FIGS. 6A and 6B show that in the two example designs, the peak wall heat flux can both be controlled to lower than 450 kW/m², which is an acceptable level for boiler tube materials.

1-8. (canceled)

9. A process for flexible energy generation using a modular pressurized combustion system, the process comprising:
providing, with at least one compressor, pressurized oxidizer gas to each of a plurality of pressurized combustion boilers in parallel;
providing, with at least one feeder, fuel to each of the plurality of pressurized combustion boilers in parallel;
providing, with at least one flue gas input unit, recycled flue gas to each of the plurality of pressurized combustion boilers in series;
recovering, with at least one heat recovery unit, heat from a flue gas output stream received from each of the plurality of pressurized combustion boilers;
filtering, with at least one particle filter, a flue gas output stream from the at least one pressurized heat recovery unit; and
cooling, with at least one integrated pollutant removal unit, a particle-free flue gas output stream received from the at least one particle filter.

10. The process of claim 9, wherein cooling with at least one integrated pollutant removal (IPR) unit comprises cooling with at least one direct contact cooling column.

11. The process of claim 9, further comprising:
heating, with heat from the at least one IPR unit, a clean particle-free flue gas output stream from the IPR unit, and
expanding, with at least one expansion turbine, a heated clean particle-free flue gas output stream received from the IPR unit.

12. The process of claim 9, further comprising purifying, with at least one CO₂ purification unit, a clean particle-free flue gas output stream received from the IPR unit.

13. The process of claim 9, wherein providing pressurized oxidizer gas comprises providing pressurized air.

14. The process of claim 9, wherein providing pressurized oxidizer gas comprises providing pressurized oxygen, and the at least one compressor further comprises at least one air separation unit.

15. The process of claim 9, wherein providing fuel comprises providing coal.

16. The process of claim 9, wherein providing fuel comprises providing a low-rank fuel.

17-20. (canceled)
